(19) United States
(12) Patent Application Publication
(10) Pub. No.: US 2023/0046035 A1
(43) Pub. Date: Feb. 16, 2023

(54) AUTHENTICATION APPARATUS AND METHOD AND NON-TRANSITORY COMPUTER READABLE MEDIUM

(71) Applicant: FUJIFILM Business Innovation Corp., Tokyo (JP)

(72) Inventor: Rie NAKAZATO, Kanagawa (JP)

(73) Assignee: FUJIFILM Business Innovation Corp., Tokyo (JP)

(21) Appl. No.: 17/544,419

(22) Filed: Dec. 7, 2021

(30) Foreign Application Priority Data
Aug. 16, 2021 (JP) 2021-132321

(51) Int. Cl. G06F 21/62

(52) U.S. Cl. CPC H04L 63/205; H04L 63/08

(57) ABSTRACT

An authentication apparatus includes a processor configured to: obtain information on a first authentication technique used by a user when the user requests authentication for a first service; and output information for presenting an additional authentication screen to a device used by the user for authentication if the first authentication technique does not satisfy a predetermined condition set for the first service, the additional authentication screen being used for requesting the user to perform additional authentication by using a second authentication technique different from the first authentication technique.

### CROSS-REFERENCE TO RELATED APPLICATIONS

This application is based on and claims priority under 35 USC 119 from Japanese Patent Application No. 2021-132321 filed Aug. 16, 2021.

### BACKGROUND

### (i) Technical Field

The present disclosure relates to an authentication apparatus and method and a non-transitory computer readable medium.

### (ii) Related Art

Japanese Unexamined Patent Application Publication No. 2019-023859 discloses a system and a method that support a multi-level and/or multi-factor authentication system and enhance it through a self-learning process. The technology disclosed in this publication makes it possible to learn user authentication levels and set a suitable security level.

Japanese Unexamined Patent Application Publication No. 2020-071513 discloses an authentication system and method that makes it possible to take security measures for a user or a terminal requesting connection via a network in accordance with various usage environments of the terminal and various requests from the user and also makes it possible to perform billing in accordance with an authentication service.

### SUMMARY

When a user logs in a service, if strict authentication using multiple authentication techniques is performed, the reliability of the service is guaranteed, but the convenience of the user is sacrificed. Conversely, using a simple authentication technique with a combination of an ID and a password does not impair the convenience of the user, but it may lower the reliability of the service.

Aspects of non-limiting embodiments of the present disclosure relate to an authentication apparatus and method and a non-transitory computer readable medium in which, when an authentication technique used by a user logging in a service does not satisfy a specific condition, the user is requested to perform additional authentication and access from this user is authorized if the resulting authentication strength satisfies a specific level or higher.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an authentication apparatus including a processor configured to: obtain information on a first authentication technique used by a user when the user requests authentication for a first service; and output information for presenting an additional authentication screen to a device used by the user for authentication if the first authentication technique does not satisfy a predetermined condition set for the first service, the additional authentication screen being used for requesting the user to perform additional authentication by using a second authentication technique different from the first authentication technique.

### BRIEF DESCRIPTION OF THE DRAWINGS

An exemplary embodiment of the present disclosure will be described in detail based on the following figures, wherein:

FIG. 1 is a schematic block diagram of an information processing system according to the exemplary embodiment;

FIG. 2 is a block diagram of the hardware configuration of an authentication apparatus;

FIG. 3 is a block diagram illustrating an example of the functional configuration of the authentication apparatus;

FIG. 4 is a flowchart illustrating authentication processing executed by the authentication apparatus;

FIG. 5 is a table illustrating setting examples of security levels of cloud services stored in a database;

FIG. 6 is a table illustrating setting examples of authentication scores stored in the database;

FIG. 7 is a table illustrating setting examples of authentication scores stored in the database;

FIG. 8 is a table illustrating examples of authentication scores by user stored in the database;

FIG. 9 is a flowchart illustrating authentication processing executed by the authentication apparatus;

FIG. 10 is a table illustrating examples of cloud services managed by group; and

FIG. 11 illustrates an example of a user interface displayed on a management terminal.

### DETAILED DESCRIPTION

An exemplary embodiment of the disclosure will be described below with reference to the accompanying drawings. In the individual drawings, identical or equivalent elements or portions are designated by like reference numeral. For the sake of representation, the dimensional ratios in the drawings are exaggerated and may be different from the actual ratios.

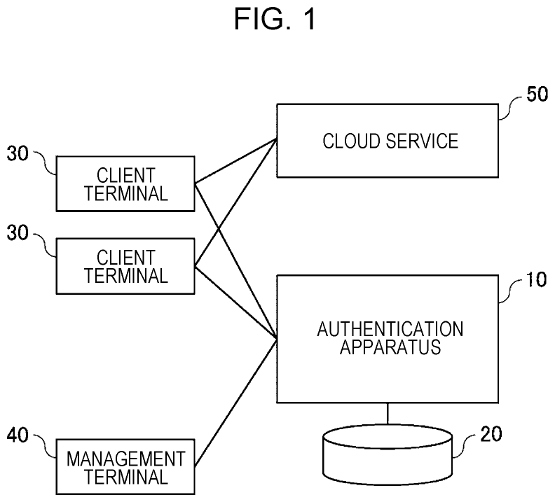

FIG. 1 is a schematic block diagram of an information processing system according to the exemplary embodiment.

The information processing system shown in FIG. 1 is a system that provides a cloud service to a user via a network. The information processing system includes an authentication apparatus 10, a database 20, client terminals 30, a management terminal 40, and a cloud service 50.

The authentication apparatus 10 performs authentication for a user using the cloud service 50. Only an authenticated user is authorized to use the cloud service 50. The specific configuration of the authentication apparatus 10 will be discussed later.

The database 20 stores information to be used when the authentication apparatus 10 authenticates a user.

The client terminals 30 are each used by a user using the cloud service 50. The client terminals 30 are not limited to a specific terminal if they have a function of connecting the corresponding client terminals 30 to a network. Examples of the client terminals 30 are personal computers, smartphones, tablet terminals, printers, and scanners. Hereinafter, the client terminals 30 will be collectively called the client terminal 30 unless it is necessary to distinguish them from each other.

The management terminal 40 is used by an administrator who manages users using the cloud service 50. By using the management terminal 40, the administrator sets settings of the cloud service 50 and settings of users using the cloud service 50.

In the cloud service 50, a server installed in a cloud provides a predetermined service to a user. The information processing system may include multiple cloud services 50. Examples of the cloud service 50 are social networking services (social media), document management services, web mail services, and web meeting services. The cloud service 50 collaborates with the authentication apparatus 10 and provides a service to a user authenticated by the authentication apparatus 10. A description will be given, assuming that plural cloud services 50 are included in the information processing system.

In the exemplary embodiment, the cloud services 50 and users are managed by group. Multiple groups may be provided. In one group, at least one cloud service 50 and at least one user are managed.

When a user uses a cloud service 50, the authentication apparatus 10 judges whether the user is authorized to use this cloud service 50. When a user uses a cloud service 50, if strict authentication using two-step authentication, for example, is performed, the reliability of the cloud service 50 is guaranteed, but the convenience of the user is sacrificed compared with when single-step authentication is performed. Conversely, using a simple authentication technique with a combination of an ID and a password does not impair the convenience of a user, but it may lower the reliability of the cloud service 50 due to some possible risk, such as the use of the same password or a leakage of the password.

To address this issue, the authentication apparatus 10 of the exemplary embodiment executes the following authentication processing. If the authentication technique used by a user to log in a cloud service 50 does not satisfy a specific condition, the authentication apparatus 10 requests the user to perform additional authentication and authorizes access from the user if the resulting authentication strength of this user is a certain level or higher. In other words, the authentication apparatus 10 requests a user to perform additional authentication only when it is necessary. The authentication strength of additional authentication may be of any level if the total authentication strength of the authentication technique of additional authentication and the authentication technique initially used by the user has a specific level or higher.

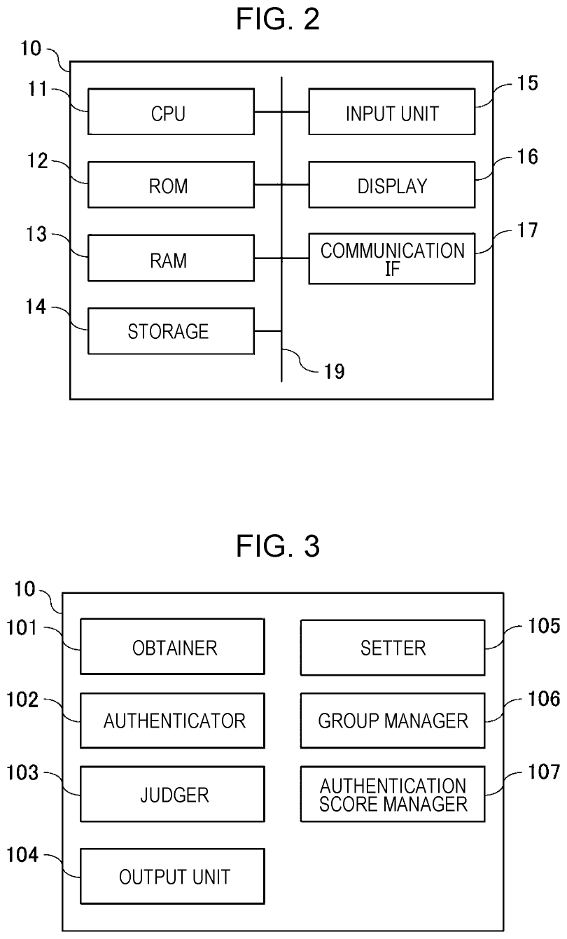

FIG. 2 is a block diagram of the hardware configuration of the authentication apparatus 10.

As shown in FIG. 2, the authentication apparatus 10 includes a central processing unit (CPU) 11, a read only memory (ROM) 12, a random access memory (RAM) 13, a storage 14, an input unit 15, a display 16, and a communication interface (IF) 17. The individual elements are connected to each other via a bus 19 so that they can communicate with each other.

The CPU 11 is a processor that executes various programs and controls the individual elements of the authentication apparatus 10. That is, the CPU 11 reads a program from the ROM 12 or the storage 14 and executes the program by using the RAM 13 as a work area. The CPU 11 executes various control operations and computing operations in accordance with programs stored in the ROM 12 or the storage 14. In the exemplary embodiment, an authentication program for authenticating a user using a cloud service 50 is stored in the ROM 12 or the storage 14.

In the ROM 12, various programs and various items of data are stored. The RAM 13 is used as a work area for temporarily storing a program or data. The storage 14 is constituted by a storage device, such as a hard disk drive (HDD), a solid state drive (SSD), and a flash memory, and stores various programs including an operating system (OS) and various items of data.

The input unit 15 includes a pointing device, such as a mouse, and a keyboard, and is used for various input operations.

The display 16 is a liquid crystal display, for example, and displays various items of information. The display 16 may be a touchscreen panel, in which case, it also serves as the input unit 15.

The communication interface 17 is used for communicating with other devices, such as the database 20, the client terminals 30, and the management terminal 40. Ethernet (registered trademark), fiber distributed data interface (FDDI), or Wi-Fi (registered trademark), for example, is used as the standard of the communication interface 17.

As a result of executing the above-described authentication program, the authentication apparatus 10 implements various functions by using the above-described hardware resources. The functions implemented by the authentication apparatus 10 will be discussed below.

FIG. 3 is a block diagram illustrating an example of the functional configuration of the authentication apparatus 10.

As shown in FIG. 3, the authentication apparatus 10 includes as the functions an obtainer 101, an authenticator 102, a judger 103, an output unit 104, a setter 105, a group manager 106, and an authentication score manager 107. The individual functions are implemented as a result of the CPU 11 reading the authentication program from the ROM 12 or the storage 14 and executing the program.

The obtainer 101 obtains information on an authentication technique used by a user to use a cloud service 50 and also obtains the content of authentication information input by the user using this authentication technique. For example, the obtainer 101 obtains information on an authentication technique used in the client terminal 30 on a login screen for a cloud service 50 displayed on the client terminal 30 and also obtains the content of authentication information input on the login screen. If the used authentication technique is password authentication using a user ID and a password, the authentication information is a user ID and a password. If the used authentication technique is one-time password authentication (OTP authentication), the authentication information is a one-time password. If the used authentication technique is biometric authentication using biometric information, the authentication information is biometric information, such as fingerprint information, vein information, and face information.

The authenticator 102 performs authentication for the cloud service 50 to be used by the user, based on the authentication information obtained by the obtainer 101.

When the authenticator 102 performs user authentication, the judger 103 judges whether the authentication technique used in user authentication satisfies a predetermined condition set for the cloud service 50, based on the information on the authentication technique obtained by the obtainer 101.

When making the above-described judgement, the judger 103 compares an authentication score with a security level set for the cloud service 50. The authentication score is a score determined in accordance with the authentication technique and/or a location where the user has requested authentication. The predetermined condition used in the above-described judgement is that the authentication score is higher than the security level. As the authentication score of the authentication technique is larger, the authentication level for this technique is higher. If the security level is found to be higher than the authentication score, the judger 103 requests the user to perform additional authentication. The judger 103 can identify the location where the user has requested authentication from the internet protocol (IP) address of the client terminal 30 used by the user for authentication.

There may be a situation where a user authenticated for one cloud service 50 wishes to switch to another cloud service 50 and use it. In this case, the judger 103 judges whether the authentication technique used by the user for the first cloud service 50 satisfies a predetermined condition set for the second cloud service 50. In this case, too, the judger 103 compares the authentication score determined in accordance with the authentication technique and/or the location where the user has requested authentication with the security level set for the second cloud service 50.

If the authentication technique used by the user for the first cloud service 50 includes a certain authentication technique, the judger 103 may judge that the predetermined condition for the second service is satisfied. For example, if biometric authentication is set as the certain authentication technique and is used by the user for performing authentication for the first cloud service 50, the judger 103 may judge that the predetermined condition for the second service is satisfied.

When making the above-described judgement using the authentication score, the judger 103 may add or subtract a certain value to or from the authentication score or apply a certain weight to the authentication score if the user has requested authentication for a cloud service 50 which belongs to a certain group.

When making the above-described judgement using the authentication score, the judger 103 may add or subtract a certain value to the authentication score or apply a certain weight to the authentication score if the user has requested authentication in a predetermined location. When making the above-described judgement using the authentication score, the judger 103 may add or subtract a certain value to the authentication score or apply a certain weight to the authentication score if the user has requested authentication in a location other than the predetermined location.

The output unit 104 outputs an authentication result obtained by the authenticator 102 to the client terminal 30. If it is found from the authentication result that the authentication technique used for authentication does not satisfy the predetermined condition set for a cloud service 50, the output unit 104 outputs a request for additional authentication to the client terminal 30.

If plural authentication techniques are available for requesting a user to perform additional authentication, the output unit 104 may request the user to perform additional authentication by using an authentication technique suitable for an environment of the user. For example, the output unit 104 may request the user to use the authentication technique suitable for the location where the user requests authentication or suitable for a device, such as the client terminal 30, used by the user to request authentication.

The setter 105 sets the security level for a cloud service 50 and the authentication score for each of the authentication technique and the authentication location. The setter 105 sets the security level and the authentication score, based on the content input into the management terminal 40 by the administrator.

The group manager 106 manages information concerning a group. For example, the group manager 106 manages information on a cloud service 50 belonging to a group and information on a user belonging to a group.

The authentication score manager 107 manages the authentication score for an authentication technique, that for an authentication location, and that of each user performing authentication.

The operation of the authentication apparatus 10 will now be described below.

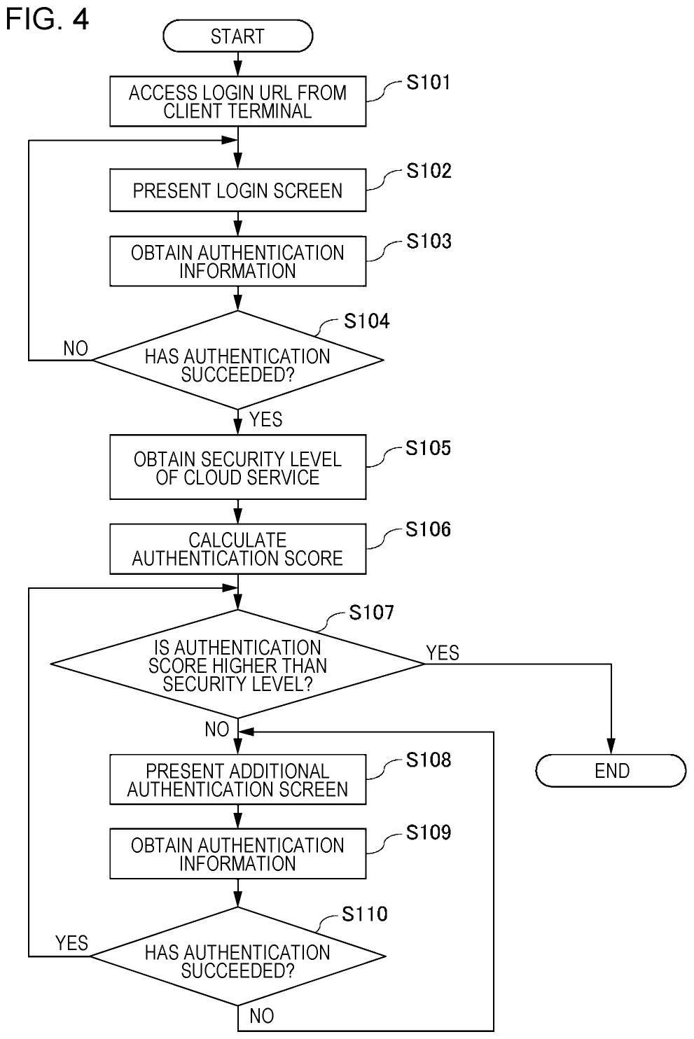

FIG. 4 is a flowchart illustrating authentication processing executed by the authentication apparatus 10. The authentication processing is executed as a result of the CPU 11 reading the authentication program from the ROM 12 or the storage 14, loading it to the RAM 13, and executing it.

The authentication processing shown in FIG. 4 is processing executed by the authentication apparatus 10 in a state in which a user has not been authenticated for any cloud service 50.

In step S101, a client terminal 30 accesses a login uniform resource locator (URL) to log in a cloud service 50. Then, in step S102, the CPU 11 presents a login screen on the client terminal 30. In step S103, when authentication information is input into the login screen on the client terminal 30, the CPU 11 obtains the input authentication information.

In step S104, the CPU 11 judges by using the obtained authentication information whether user authentication has successfully been performed. If user authentication has not succeeded (NO in step S104), the CPU 11 returns to step S102 to present the login screen on the client terminal 30.

If user authentication has succeeded (YES in step S104), the CPU 11 obtains the security level of the cloud service 50 from the database 20 in step S105.

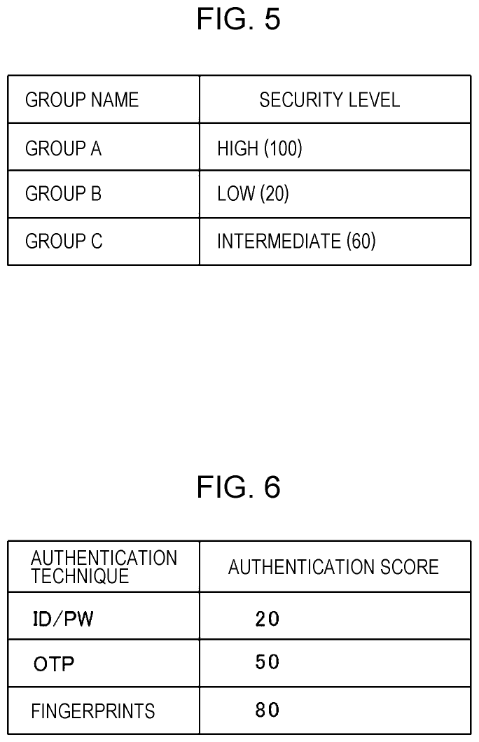

FIG. 5 is a table illustrating setting examples of the security levels of cloud services 50 stored in the database 20. In the exemplary embodiment, the security levels of the cloud services 50 are set by group. The security level may alternatively be set for each cloud service 50.

In step S106, the CPU 11 obtains individual authentication scores from the database 20 based on the authentication technique used by the user and the location where the user has requested authentication, and calculates the total authentication score.

FIG. 6 is a table illustrating setting examples of authentication scores stored in the database 20. The authentication scores shown in FIG. 6 are those set in accordance with the authentication technique used by a user. In the exemplary embodiment, the authentication score is 20 for authentication using an ID and a password; the authentication score is 50 for authentication using a one-time password; and the authentication score is 80 for authentication using fingerprints.

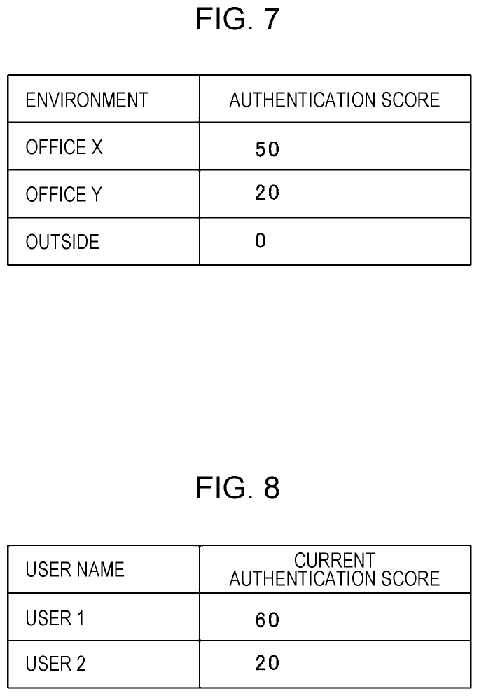

FIG. 7 is a table illustrating setting examples of authentication scores stored in the database 20. The authentication scores shown in FIG. 7 are those set in accordance with the location where a user has requested authentication. In the exemplary embodiment, the authentication score is 50 for authentication requested at office X; the authentication score is 20 for authentication requested at office Y; and the authentication score is 0 for authentication requested outside the office.

In step S107, the CPU 11 compares the authentication score calculated in step S106 with the security level obtained in step S105 and judges whether the authentication score is higher than the security level.

If the authentication score is found to be higher than the security level in step S107 (YES in step S107), the CPU 11 completes user authentication and terminates the processing. Upon completion of authentication by the authentication apparatus 10, the user is able to use the cloud service 50.

If the authentication score is not higher than the security level (NO in step S107), the CPU 11 presents an additional authentication screen on the client terminal 30 in step S108.

In step S108, the CPU 11 presents the additional authentication screen using an authentication technique different from the technique used by the user on the login screen displayed in step S102. If plural authentication techniques are available for the user to use on the additional authentication screen, the CPU 11 may present the additional authentication screen using an authentication technique having a higher authentication score or the additional authentication screen using an authentication technique that can be used by the client terminal 30 of the user.

A specific example of judging processing in step S107 will be discussed below by taking the setting examples in FIGS. 5 through 7.

If the user belongs to group B and has logged in at office X by using the ID and the password, the total authentication score is 70 since the authentication score for authentication requested at office X is 50 and that of the authentication technique is 20. The security level set for group B is 20. The total authentication score is thus higher than the security level, and additional authentication for the user is not necessary.

If the user belongs to group C and has logged in outside the office by using the ID and the password, the total authentication score is 20 since the authentication score for authentication requested outside the office is 0 and that of the authentication technique is 20. The security level set for group C is 60. The security level is thus higher than the total authentication score, and additional authentication for the user is necessary. In this case, the CPU 11 presents on the client terminal 30 the additional authentication screen for instructing the user to perform authentication using a one-time password or fingerprints so that the authentication score becomes higher than the security level. If the client terminal 30 does not have a function of inputting fingerprints, the CPU 11 presents the additional authentication screen for one-time password authentication on the client terminal 30.

The authentication technique to be used for additional authentication may not necessarily be a technique whose authentication score is higher than that for the authentication technique initially used by the user.

When the user has input authentication information on the additional authentication screen, the CPU 11 obtains the input authentication information in step S109.

In step S110, the CPU 11 judges by using the obtained authentication information whether user authentication has successfully been performed. If user authentication has not succeeded (NO in step S110), the CPU 11 returns to step S108 to present the additional authentication screen on the client terminal 30.

If user authentication has succeeded (YES in step S110), the CPU 11 makes the judgement in step S107 again. The CPU 11 repeats steps S107 through S110 until the authentication score is found to be higher than the security level in step S107.

After completing user authentication, the CPU 11 stores the authentication score obtained at this moment in the database 20. FIG. 8 is a table illustrating examples of the authentication scores by user stored in the database 20.

As a result of executing the processing in FIG. 4, when the authentication technique used by a user to log in a cloud service 50 does not satisfy a specific condition, the authentication apparatus 10 requests the user to perform additional authentication and authorizes access from the user if the resulting authentication strength of this user is a certain level or higher. In other words, as a result of executing the processing in FIG. 4, the authentication apparatus 10 can request a user to perform additional authentication only when it is necessary.

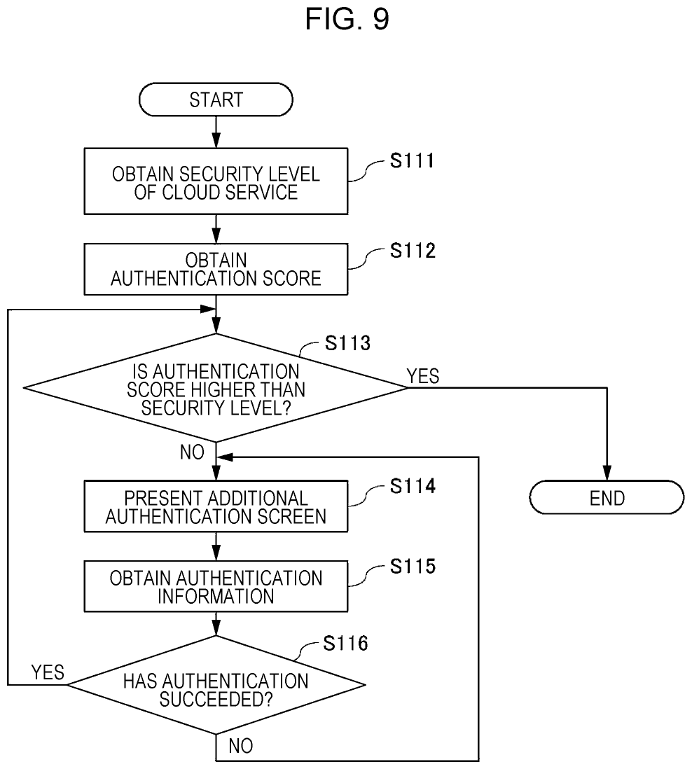

FIG. 9 is a flowchart illustrating authentication processing executed by the authentication apparatus 10. The authentication processing is executed as a result of the CPU 11 reading the authentication program from the ROM 12 or the storage 14, loading it to the RAM 13, and executing it.

The authentication processing shown in FIG. 9 is processing executed by the authentication apparatus 10 when a user authenticated for a certain cloud service 50 wishes to use another cloud service 50.

In step S111, the CPU 11 obtains from the database 20 the security level of the cloud service 50 to which the user wishes to switch from the previous cloud service 50.

In step S112, the CPU 11 obtains the authentication score of the user from the database 20. This authentication score is the one when the user has been authenticated for the previous cloud service 50.

In step S113, the CPU 11 compares the authentication score obtained in step S112 with the security level obtained in step S111 and judges whether the authentication score is higher than the security level.

If the authentication score is found to be higher than the security level in step S113 (YES in step S113), the CPU 11 completes user authentication and terminates the processing. Upon completion of authentication by the authentication apparatus 10, the user is able to use the new cloud service 50.

If the authentication score is not higher than the security level (NO in step S113), the CPU 11 presents an additional authentication screen on the client terminal 30 in step S114.

When authentication information is input on the additional authentication screen, the CPU 11 obtains the input authentication information in step S115.

In step S116, the CPU 11 judges by using the obtained authentication information whether user authentication has successfully been performed.

If user authentication has not succeeded (NO in step S116), the CPU 11 returns to step S114 to present the additional authentication screen on the client terminal 30.

If user authentication has succeeded (YES in step S116), the CPU 11 makes the judgement in step S113 again. The CPU 11 repeats steps S113 through S116 until the authentication score is found to be higher than the security level in step S113.

After completing user authentication, the CPU 11 stores the authentication score obtained at this moment in the database 20.

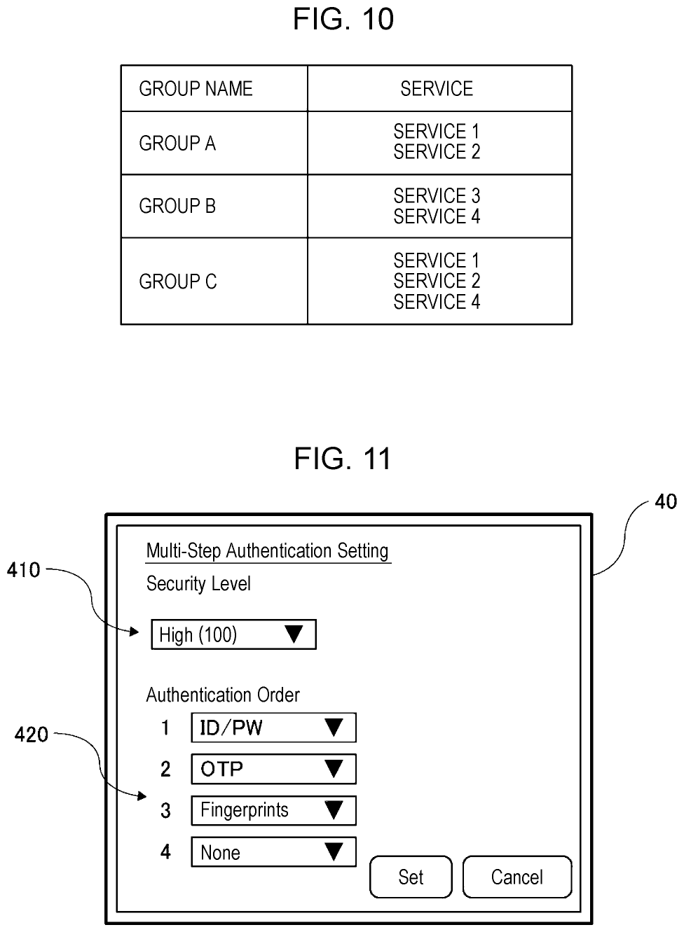

FIG. 10 is a table illustrating examples of cloud services 50 managed by group. In the example in FIG. 10, service 1 and service 2 belong to group A, service 3 and service 4 belong to group B, and service 1, service 2, and service 4 belong to group C.

It is now assumed that a user already uses a cloud service 50 belonging to group B (security level is 20) and wishes to use a cloud service 50 belonging to group A (security level is 100) and that the current authentication score of this user is 50. Since the security level of group A is higher than the authentication score, the CPU 11 presents the additional authentication screen to the client terminal 30 of this user. In this case, the CPU 11 presents the additional authentication screen for authentication using fingerprints so that the authentication score becomes higher than the security level.

The client terminal 30 may not be able to perform fingerprint authentication, in which case, it is not possible to make the authentication score become higher than the security level. In a user environment where the authentication score cannot exceed the security level by using any type of additional authentication, the CPU 11 may present a message that the user is not able to use the cloud service 50 in the current environment to the client terminal 30.

As a result of executing the processing in FIG. 9, when the authentication technique used by a user to log in another cloud service 50 does not satisfy a specific condition, the authentication apparatus 10 requests the user to perform additional authentication and authorizes access from the user if the resulting authentication strength of this user is a certain level or higher. In other words, as a result of executing the processing in FIG. 9, the authentication apparatus 10 requests a user to perform additional authentication only when it is necessary.

The authentication apparatus 10 may suggest the security level of a cloud service 50 to a group administrator.

FIG. 11 illustrates an example of a user interface displayed on the management terminal 40. The user interface shown in FIG. 11 is the one for setting the security level of a cloud service 50 belonging to a certain group and the order of authentication techniques to be requested to a user. The CPU 11 may present a recommended security level of the cloud service 50, based on the settings of another group using the same cloud service 50. The content of the settings set on the user interface in FIG. 11 is stored in the database 20.

Authentication processing executed by the CPU as a result of reading and executing a software (program) may be executed by various processors other than the CPU. Examples of the processors are dedicated electric circuits, for example, a programmable logic device (PLD), such as a field-programmable gate array (FPGA), designed to be reconfigured by a customer or a designer after manufacturing, and processors having a dedicated circuit configuration customized for a particular use, such as an application specific integrated circuit (ASIC). Authentication processing may be executed by one of the above-described various processors or by a combination of two or more processors of the same type or different types (such as a combination of plural FPGAs or a combination of a CPU and an FPGA). The hardware configuration of these various processors is, specifically, an electric circuit as a combination of circuit elements, such as semiconductor elements.

In the above-described exemplary embodiment, the authentication program is stored (installed) in the ROM or the storage. However, this is only an example. The authentication program may be recorded on a non-transitory computer readable medium, such as a compact disk read only memory (CD-ROM), a digital versatile disk (DVD)-ROM, and a universal serial bus (USB) memory, and be provided. The authentication program may be downloaded from an external device via a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An authentication apparatus comprising:
a processor configured to:
obtain information on a first authentication technique used by a user when the user requests authentication for a first service; and
output information for presenting an additional authentication screen to a device used by the user for authentication if the first authentication technique does not satisfy a predetermined condition set for the first service, the additional authentication screen being used for requesting the user to perform additional authentication by using a second authentication technique different from the first authentication technique.

2. The authentication apparatus according to claim 1, wherein the processor is configured to output the information for presenting the additional authentication screen to the device used by the user in a case in which the user has been authenticated for the first service and in which the user requests authentication for a second service and if an authentication technique used by the user when the user has been authenticated for the first service does not satisfy a predetermined condition set for the second service.

3. The authentication apparatus according to claim 2, wherein the processor is configured to judge that the predetermined condition set for the second service is satisfied when the user has been authenticated for the first service by using a predetermined authentication technique.

4. The authentication apparatus according to claim 1, wherein the processor is configured to request the user to perform additional authentication by using an authentication technique suitable for an environment of the user if a plurality of authentication techniques are available for requesting the user to perform additional authentication.

5. The authentication apparatus according to claim 4, wherein the environment is a location where the user requests authentication.

6. The authentication apparatus according to claim 4, wherein the environment is the device used by the user to request authentication.

7. The authentication apparatus according to claim 1, wherein the processor is configured to judge whether the first authentication technique satisfies the predetermined condition set for the first service by comparing an authentication score with a security level set for the first service, the authentication score being set in accordance with an environment in which the user performs authentication.

8. The authentication apparatus according to claim 7, wherein the processor is configured to add a predetermined value to the authentication score if the user has requested authentication for a service belonging to a predetermined group.

9. The authentication apparatus according to claim 7, wherein the processor is configured to apply a predetermined weight to the authentication score if the user has requested authentication in a predetermined location.

10. The authentication apparatus according to claim 7, wherein the processor is configured to apply a predetermined weight to the authentication score if the user has requested authentication in a location other than a predetermined location.

11. The authentication apparatus according to claim 7, wherein the processor is configured to calculate the authentication score, based on a score determined in accordance with the first authentication technique used by the user.

12. The authentication apparatus according to claim 7, wherein the processor is configured to calculate the authentication score, based on a score determined in accordance with a location where the user has requested authentication.

13. The authentication apparatus according to claim 1, wherein:
the first service belongs to a plurality of groups; and
the processor is configured to present a recommended security level for the first service which belongs to one of the plurality of groups, based on a security level set for the first service which belongs to another one of the plurality of groups.

14. An authentication method comprising:
obtaining information on a first authentication technique used by a user when the user requests authentication for a first service; and
outputting information for presenting an additional authentication screen to a device used by the user for authentication if the first authentication technique does not satisfy a predetermined condition set for the first service, the additional authentication screen being used for requesting the user to perform additional authentication by using a second authentication technique different from the first authentication technique.

15. A non-transitory computer readable medium storing a program causing a computer to execute a process, the process comprising:
obtaining information on a first authentication technique used by a user when the user requests authentication for a first service; and
outputting information for presenting an additional authentication screen to a device used by the user for authentication if the first authentication technique does not satisfy a predetermined condition set for the first service, the additional authentication screen being used for requesting the user to perform additional authentication by using a second authentication technique different from the first authentication technique.
